(19) United States
(12) Patent Application Publication
(10) Pub. No.: US 2023/0318940 A1
(43) Pub. Date: Oct. 5, 2023

(54) METHOD AND APPARATUS FOR CONFIGURING AN INFORMATION HANDLING SYSTEM, METHOD AND APPARATUS FOR MANAGING A SERVICE, COMPUTER PROGRAM, AND NON-VOLATILE STORAGE MEDIUM

(71) Applicant: Fujitsu Technology Solutions GmbH, München (DE)

(72) Inventors: Steffen Müter, München (DE); Koen van Eig, München (DE)

(21) Appl. No.: 18/022,649

(22) PCT Filed: Sep. 30, 2021
(86) PCT No.: PCT/EP2021/076984

§ 371 Date: Feb. 22, 2023

(30) Foreign Application Priority Data
Oct. 2, 2020 (DE) 10 2020 125 869.0

(51) Int. Cl. H04L 41/5054

(52) U.S. Cl. CPC H04L 41/5054

(57) ABSTRACT

A method of configuring an information handling system includes detecting an input signal regarding a service, wherein the input signal includes information regarding the selected service and the information handling system is configured for the selected service; determining at least one provisioning pattern from a plurality of stored provisioning patterns, wherein each provisioning pattern of the plurality of provisioning patterns provides a mapping between a service and at least one execution pattern; determining at least one execution pattern from a plurality of execution patterns based on the determined at least one provisioning pattern, wherein each execution pattern includes computer readable instructions for configuring an information handling system; determining at least one execution parameter based on the determined at least one provisioning pattern; and executing the at least one determined execution pattern based on the determined at least one execution parameter to configure the information handling system for the selected service.

### TECHNICAL FIELD

This disclosure relates to a method and an apparatus for configuring an information handling system, as well as a method and an apparatus for managing a service on an information handling system, and a computer program and a non-volatile storage medium.

### BACKGROUND

With an increasing digitization in industry, working environments and society, IT services become more and more important. Providing and managing such IT services, however, usually causes extensive technical and organizational effort.

Time-consuming negotiations need to be conducted for a supplier of such IT service to determine what hardware and software the customer requires for the requested IT service. Hardware needs to be ordered and delivered, systems need to be provisioned, configured, software needs to be installed.

Since every customer usually has different requirements such as, for example, an individual number of employees, for which the requested service should be provided, an IT service supplier needs to individually design the IT solution by providing individually provisioned infrastructure and services. Accordingly, also an individual management of the service is necessary, once the service is provisioned. This is not only time-consuming, but also requires extensive manpower from IT specialists and technicians. In light of the above, provisioning and managing such IT services causes high expenses for the customers.

It could therefore be helpful to provide methods, apparatuses, a computer program and a non-volatile storage medium to address the above-mentioned problems.

### SUMMARY

We provide a method of configuring an information handling system, the method including detecting, by a management device, an input signal regarding a service, which service is selected by a customer, wherein the input signal includes information regarding the selected service and wherein the information handling system is to be configured for the selected service; determining, by the management device, at least one provisioning pattern from a plurality of stored provisioning patterns based on the information regarding the selected service, wherein each provisioning pattern of the plurality of provisioning patterns provides a mapping between a service and at least one execution pattern; determining, by the management device, at least one execution pattern from a plurality of execution patterns based on the determined at least one provisioning pattern, wherein each execution pattern includes computer readable instructions for configuring an information handling system; determining, by the management device, at least one execution parameter based on the determined at least one provisioning pattern; and executing, by the management device, the at least one determined execution pattern based on the determined at least one execution parameter to configure the information handling system for the selected service.

We also provide an apparatus for configuring an information handling system and/or managing a service on an information handling system, the apparatus including a management device, wherein, to configure the information handling system, the management device is configured to detect an input signal regarding a service, which service is selected by a customer, wherein the input signal includes information regarding the selected service and wherein the information handling system is to be configured for the selected service; determine at least one provisioning pattern from a plurality of stored provisioning patterns based on the information regarding the selected service, wherein each provisioning pattern of the plurality of provisioning patterns provides a mapping between a service and at least one execution pattern, and wherein each execution pattern includes computer readable instructions for configuring an information handling system; determine at least one execution pattern from a plurality of execution patterns based on the determined at least one provisioning pattern; determine at least one execution parameter based on the determined at least one provisioning pattern and the information regarding the selected service; and execute the at least one determined execution pattern based on the determined at least one execution parameter to configure the information handling system for the selected service; and/or wherein for managing the service on the information handling system, the management device is configured to determine a task of a service running on an information handling system, which task is to be executed; request, from a configuration management database, CMDB, information regarding the service running on the information handling system, wherein the information regarding the service includes information regarding at least one provisioning pattern, based on which the information handling system is configured; determine at least one execution pattern from a plurality of execution patterns according to the information regarding the service and regarding the task which is to be executed; and execute the at least one determined execution pattern to manage the service on the information handling system.

We further provide a method of managing a service on an information handling system, the method including determining, by a management device, a task of a service running on an information handling system, which task is to be executed; requesting, by the management device, from a configuration management database, CMDB, information regarding the information handling system that is running the service, wherein the information regarding the information handling system includes information regarding at least one provisioning pattern, based on which the information handling system is configured; determining, by the management device, at least one execution pattern from a plurality of execution patterns according to the information regarding the information handling system that is running the service and regarding the task which is to be executed; and executing, by the management device, the at least one determined execution pattern to manage the service on the information handling system.

### BRIEF DESCRIPTION OF THE DRAWINGS

FIG. 1 shows a structural diagram of an apparatus according to an example.

FIG. 2 shows a structural diagram of a blueprint and multiple runbooks according to an example.

FIG. 3 shows a flowchart of a method of configuring an information handling system according to an example.

FIG. 4 shows a flowchart of a method of managing a service on an information handling system according to an example.

### LIST OF REFERENCE SIGNS

1 apparatus
2 information handling system
3 network
4 input device
5 management device
6 communication network
7 application programming interface gateway
8 management platform
9 execution tool
10 software repository
11 configuration management database
12 storage device
13 blueprint
14 runbook
15 customer key parameter
16 provisioning standard
300, 400 method
301 to 405 steps

### DETAILED DESCRIPTION

Our method of configuring an information handling system comprises the following steps:
detecting, by a management device, an input signal regarding a service, which service is selected by a customer, wherein the input signal comprises information regarding the selected service;
determining, by the management device, at least one provisioning pattern from a plurality of stored provisioning patterns based on the information regarding the selected service, wherein each provisioning pattern of the plurality of provisioning patterns provides a mapping between a service and at least one execution pattern;
determining, by the management device, at least one execution pattern from a plurality of execution patterns based on the determined at least one provisioning pattern, wherein each execution pattern comprises instructions for configuring an information handling system;
determining, by the management device, at least one execution parameter based on the determined at least one provisioning pattern; and
executing, by the management device, the at least one determined execution pattern based on the determined at least one execution parameter.

Information handling systems configured for a service of a customer in this context comprise, for example, server systems, virtual machines, workstation systems, cloud computing systems, hybrid-IT-systems, storage systems, networking systems, or any other kind of computer systems, which are arranged to run an IT service. The information handling system may also comprise one or more of the above, for example, also a mix of different system types. The information handling system may further either be based on a cloud-computing solution or on an on-premise solution or a combination of both, for example.

Service in this context may comprise anything of provisioning and orchestrating an information handling system to running and maintaining tasks on an information handling system. Possible services in this context may be, for example, at least one of the following: provisioning and orchestrating an information handling system, managing the information handling system, provisioning, orchestrating and/or managing an SAP system, provisioning, orchestrating and/or managing workplace services, for example, remote workplace solutions, provisioning, orchestrating and/or managing storage services, provisioning, orchestrating and/or managing cloud- and hybrid-IT systems, providing application management services, provisioning, orchestrating and/or managing database services, provisioning, orchestrating and/or managing Azure SQL database instances and many more. After the information handling system is configured, operations of the service are running on the information handling system. The management device may then further be arranged to manage, by executing corresponding execution patterns, the service running on the information handling system.

The information regarding the selected service comprises information regarding which service is selected by the customer. For example, when a customer selects a service such as the managed SAP service, the information comprises an indication that the customer selected a “managed SAP service.” Any other kind of service in that regard is of course also possible.

Furthermore, the information regarding the selected service may comprise information that allows customization of the services with respect to the customer's preferences regarding an extent or size or other parameters of the service. For example, the information may comprise an indication that a service is needed for 100 user accounts and/or the requested service includes provisioning of 10 terabytes of storage space. Additionally or alternatively, the information regarding the selected service may also comprise information regarding a recovery time, a required up-time, service level agreements, information regarding a setup of the information handling system such as single-site or multi-site setups, cloud or on-premise setups, information regarding preferred software and/or tools for the service and the like.

This information may either be directly provided by the customer that selects the service, i.e., the customer selects, for example, “a managed SAP service” and then provides information the service is needed for “100 user accounts,” or the information may be derived from a customer input, i.e., the customer selects, for example, a managed storage service, which does not cost more than 100 € per month and from the input, it is derived that up to 10 terabytes of managed storage space may be provisioned to the customer according to the input.

The provisioning pattern, which may also be referred to as a “blueprint,” provides a mapping between a service and at least one execution pattern. For example, for each offered service that can be selected by a customer, one specific provisioning pattern is provided. The provisioning patterns are the same regarding a same service, irrespective of which customer selects the service. Only a selection of respective provisioning patterns depends on which service is selected. The provisioning pattern is executed by the management device and, thereby, the mapped execution patterns are determined which need to be executed. With other words, the provisioning pattern comprises a list of steps that need to be performed to configure the information handling system for the selected service, whereby each of the steps relates to one or more corresponding execution pattern.

The execution pattern, which may also be referred to as a “runbook,”, comprises instructions for configuring an information handling system. Those instructions comprise instructions for tasks which need to be performed to provision and orchestrate the information handling system to be able to execute the service that the customer selected. The at least one execution pattern may be, in particular, a sequence of execution patterns, which, in the step of executing the at least one execution pattern, are executed consecutively.

The execution patterns are the same for every customer. Only a selection of the execution patterns depends on the determined provisioning pattern and, therefore, depends on the selected service. The determined execution patterns are executed according to the input signal regarding the service, which provides the customization of the selected service for each customer.

The execution patterns comprise computer readable instructions, for example, in the form of programming code, which, when executed, perform the tasks to which they relate. Executing, by the management device, the execution pattern in this context means calling up, by the management device, the execution pattern and performing tasks of the execution pattern or instructing the information handling system to perform tasks accordingly.

For example, when a service “managed operating system” is selected by the customer and a respective provisioning pattern has been determined, the step of executing the at least one execution pattern comprises consecutively executing, for example, some or all of the following separate execution patterns: providing a required server space, setting up virtual machines on the server space, installing an operating system on each virtual machine, configuring and managing the installed systems and the like. Each of those tasks is carried out by executing a respective execution pattern.

With other words, the above may be summarized as follows: For each service that may be selected by the customer, a provisioning pattern exists. Each provisioning pattern provides information regarding tasks that need to be performed to provide an information handling system for running the respective service and/or tasks that need to be performed to run the service itself. For each of those tasks, execution patterns exist. The tasks to configure the information handling system are performed by executing the execution patterns.

An advantage of the method is that the method provides an automated solution for provisioning and orchestration of an information handling system for running a service. This allows a time, used for provisioning and orchestration of such information handling system, to be significantly reduced. A conventional provisioning of information handling systems for running services usually takes several days, weeks or even months. With the method according to the first aspect, provisioning and orchestration of the information handling system may take only a few hours, minutes, or even seconds. Additionally, due to the automated provisioning and orchestration of the information handling system, manpower from technicians and IT specialists can be significantly reduced. Ultimately, the above significantly reduces costs for configuring an information handling system for running a service.

Moreover, the provisioning and orchestration of an information handling system for running a service is moved from a physical layer to an Internet Protocol (IP) based layer. With other words, instead of providing and installing the information handling system on a physical system, the information handling system can be provided and managed via the Internet. This allows an information handling system to be provisioned and orchestrated irrespective of where the customer and the supplier are located.

Another advantage is that a customer may easily request services and a provisioning of an information handling system by selecting an offered service. The customer does not need extensive technical knowledge or help from IT specialists, for example, regarding what infrastructure would be needed for such service. Moreover, the customer may customize, via the input signal, a configuration of the information handling system and the respective service. For example, the customer may choose whether the service should be provided via a cloud solution or via an on-premise solution, or any other of the above-mentioned options concerning the input information regarding the selected service. The requested service, however, is reliably provided to the customer in either configuration and the customer does not see any difference in the provided service itself.

The method may be a computer-implemented method.

Before the step of detecting, by a management device, an input signal, the method may further comprise:
displaying, by a displaying device, information regarding at least one service for which at least one service pattern is stored, wherein the service selected by the customer comprises at least one of the displayed services.

This allows the customer to select a service from multiple provided services directly from the displayed services. The customer can independently choose one or more of a plurality of services, which fits his needs. An advantage herein is that the customer is enabled to select services according to his needs and does not have to rely on IT specialists and technicians. The displaying of the selectable services may be done, for example, via a service platform such as “ServiceNow.” The service platform may be a web portal that comprises a service catalogue.

Moreover, via the displaying device, the customer may also be prompted to input all required information that the management device needs to determine the provisioning pattern, to determine the execution pattern and/or to determine the execution parameter. What information is to be prompted is known to the service platform or may be requested from the service platform from the management device.

Moreover, it allows the supplier to predetermine a number and types of services that are to be offered. By predetermining the number and types of offered services, the supplier can adjust a complexity of the method of configuring the information handling system. In particular, by adjusting a number and type of offered services, a number and complexity of the provisioning patterns and the execution patters can be adjusted, which allows an adjustment of a complexity of the management device. In particular, a storage space and processing power, as well as a processing time of the management device, may be adjusted.

This way, the supplier may also request from the customer necessary information regarding the configuration of the information handling system. For example, the offer may be displayed in a manner that the customer agrees with all given information or the customer is prompted to input all necessary information.

Advantageously, the determining, by the management device, at least one execution pattern from a plurality of execution patterns may be further based on the information regarding the selected service.

The at least one execution pattern may comprise at least one executable script comprising the instructions for configuring the information handling system.

The executable scripts may be stored, for example, in one or more software repositories, e.g., in distributed version-control systems, for example, Git systems. An advantage of the at least one execution pattern comprising at least one executable script is that those execution pattern may be written and managed specifically for the configuration tasks, which need to be executed during configuration of an information handling system according to a selected service.

A management of such execution patterns is automated in an advantageous example. The management of an execution pattern may, for example, comprise updating the execution pattern. In, for example, software regarding a task performed by the execution pattern has been changed such as a security patch has been provided for a program installed and/or managed by the execution pattern, the execution pattern may need to be updated accordingly. This updating may be performed automatedly.

At least one execution patter may be mapped by at least two different provisioning patterns to at least two different services. With other words, the same execution pattern may be used for configuring information handling systems according to different services.

An advantage of mapping at least one execution pattern to at least two different services is that thereby, a number of execution patterns that need to be scripted and maintained, may be reduced. This may reduce processing power and processing time as well as storage space needed for the execution patterns. In general, a complexity of the method of configuring an information handling system may be reduced this way.

The step of determining, by the management device, at least one execution parameter may comprise:
analyzing the information regarding the selected service of the input signal;
determining at least one provisioning standard for the selected service based on the analyzed information regarding the selected service; and
determining the at least one execution parameter based on the determined at least one provisioning standard.

The at least one provisioning standard may, for example, be defined regarding an extent or size of the selected service or the information handling system, which is to be configured. Different provisioning standards may be labeled, for example, as size S, size M, size L, size XL and the like, wherein regarding a provisioning of storage space, size S relates to a storage space of less than 100 gigabytes, size M relates to a storage space between 101 gigabytes and 500 gigabytes, size L relates to a storage space between 501 gigabytes and 1 terabyte and size XL relates to a storage space of more than 1 terabyte. Similar standards may also be defined regarding other subjects, for example, regarding a number of users, for which a service is provided, regarding number of servers provided, regarding a number of network switches, regarding a computing power which is provided, regarding network capability, bandwidth reliability and the like. The at least one provisioning standard may also scale according to two or more of the above-mentioned or other subjects.

For each offered service, i.e., for each provisioning pattern, at least one standard may be defined. Also regarding the same subject, for example, storage space, different standards may be defined for different services. For example, while a storage space standard in a “managed storage space” service may define size S as less than 100 gigabytes, a storage space standard in a “managed operating system” service may define size S as less than 500 gigabytes. The standards may be defined according to preferences of a supplier and/or according to needs of customers, in particular according to reoccurring similar needs of different customers.

An advantage of defining and using those standards is, for example, that a complexity of the provisioning system is reduced. The provisioning patterns and the execution patterns may be provided in a manner best fitting to the standardized sizes. Also, a number of provisioning patterns and execution patterns that need to be produced and managed may be reduced this way. In particular, by selecting appropriate standards, the supplier may adjust his offers with a best possible fit to customers' needs while keeping an effort and complexity of the offered services low.

Advantageously, the determining, by the management device, at least one execution pattern from a plurality of execution patterns may be further based on the at least one determined provisioning standard.

We also provide an apparatus for configuring an information handling system comprises a management device, wherein:
the management device is configured to detect an input signal regarding a service, which service is selected by a customer, wherein the input signal comprises information regarding the selected service;
the management device is configured to determine at least one provisioning pattern from a plurality of stored provisioning patterns based on the information regarding the selected service, wherein each provisioning pattern of the plurality of provisioning patterns provides a mapping between a service and at least one execution pattern, and wherein each execution pattern comprises instructions for configuring an information handling system;
the management device is further configured to determine at least one execution pattern from a plurality of execution patterns based on the determined at least one provisioning pattern;
the management device is further configured to determine at least one execution parameter based on the determined at least one provisioning pattern and the information regarding the selected service; and
the management device is further configured to execute the at least one determined execution pattern based on the at least one determined execution parameter.

The management device may be any kind of device that is arranged to receive a signal from a customer selecting an offered service, which he intends to run on an information handling system.

The management device may further be, for example, part of a management platform, in particular a cloud management platform, or is arranged to communicate with such management platform. Such platform can be run on any possible computer system, for example, on a cloud system, a virtual system, a cluster computing system and the like. The management device may further comprise multiple entities, for example, a first entity for detecting the input signal, a second entity for determining and executing the at least one provisioning pattern and a third entity for determining and executing the at least one execution pattern. The second entity may be, for example, the management platform “Morpheus” from MorpheusData, LLC. The third entity may be, for example, a software provisioning, configuration management, and application-deployment tool, which enables infrastructure as program code. As an example, the third entity of the management device may use the tool “Ansible,” developed by AnsibleWorks, Inc.

Advantageously, the apparatus may further comprise at least one storage device, wherein the plurality of provisioning patterns and/or the plurality of execution patterns are executable scripts, stored on the at least one storage device.

We further provide a method of managing a service on an information handling system comprising:
determining, by a management device, a task of a service running on an information handling system, which task is to be executed;
requesting, by the management device, from a configuration management database, CMDB, information regarding the information handling system that is running the service, wherein the information regarding the service comprises information regarding at least one provisioning pattern, based on which the information handling system is configured;
determining, by the management device, at least one execution pattern from a plurality of execution patterns according to the information regarding the information handling system that is running the service and regarding the task which is to be executed; and
executing, by the management device, the at least one determined execution pattern.

In this context, the information regarding the information handling system running the service, which is requested from the CMDB, may comprise, for example, information regarding the customer, information regarding the information handling system of the customer and/or information regarding services which are provided for the customer, in particular information regarding provisioning patterns used and, for example, information regarding an execution parameter. The information handling system of the customer may comprise hardware owned by the customer but may also comprise cloud and/or hybrid systems, which are based on hardware that is not owned by the customer.

The task of the service may be triggered by a customer requesting, for example, a change of a service provided to him, or may be a reoccurring task or independently triggered task. A reoccurring or independently triggered task may be triggered, for example, by the management device, in particular by a service platform provided by or via the management device. The service platform may be, for example, the above-mentioned first entity of the management device. The reoccurring or independently triggered task may be triggered, for example, based on information that is stored in the CMDB. A reoccurring task may be, for example, an updating of a service or of an information handling system provided for the customer or performing a scheduled backup. Furthermore it may be possible that the task is triggered, for example, by an executed execution pattern.

An advantage of the method is that an automated managing of a service on an information handling system may be provided. Accordingly, as discussed in detail with regard to the first described method, in particular with regard to automation, also in this example, manpower, processing time and costs may be reduced.

The method may be a computer-implemented method.

Advantageously, the method may further comprise:
detecting, by the management device, an input signal regarding a task of a service running on an information handling system, which task is to be executed, wherein the input signal comprises information regarding the task, wherein determining, by a management device, a task of a service running on an information handling system, which task is to be executed is based on the detected input signal.

The input signal may be provided, for example, by a cron job, by a user (i.e., the customer or service provider) via a portal of via an API.

The execution pattern may comprise:
instructions for managing the selected service on the configured information handling system, and/or
instructions for changing a configuration of the information handling system.

Managing the service in that context may comprise, for example, starting, stopping, updating or performing a backup of the service, providing a customer service regarding the service, providing a ticketing, billing and/or reporting opportunity regarding the service and the like. Changing a configuration in that context may comprise, for example, changing a storage size, changing a number of user accounts provided for the customer, adding additional applications and/or other features to an existing service or the like. In particular, changing a configuration of the information handling system may comprise changing the execution parameters and/or moving from one standard to another standard of a system that has been provisioned and orchestrated, for example, with the first described method.

We still further provide an apparatus for managing a service on an information handling system comprising a management device, wherein:
the management device is configured to determine a task of a service running on an information handling system, which task is to be executed;
the management device is further configured to request, from a configuration management database, CMDB, information regarding the service running on the information handling system, wherein the information regarding the service comprises information regarding at least one provisioning pattern, based on which the information handling system is configured;
the management device is further configured to determine at least one execution pattern from a plurality of execution patterns according to the information regarding the service and regarding the task which is to be executed; and
the management device is further configured to execute the at least one determined execution pattern.

Advantageously, the apparatus may further comprise a storage device, wherein the plurality of the execution patterns is stored on the storage device.

The management device, the storage device and the CMDB may be connected via a communication network and/or a service bus and/or an application programming interface, API.

The communication network may be a communication network including internet protocol type networks. The service bus may be an enterprise service bus, ESB, which implements a communication system between mutually interacting software applications in a service-oriented architecture (SOA). Via the service bus, the connected entities may communicate with each other via multiple predetermined commands. The communication via the service bus is based on transmission control protocol, TCP, traffic.

An advantage of this example is that a direct and effortless communication between the entities of the apparatus is ensured. Each entity may comprise a gateway to the communication network, the service bus, and/or the API and, therefore, individual connections between the different entities may be reduced or omitted. Moreover, it provides a high flexibility to the system, allowing an effortless connecting of new entities and disconnecting of existing entities from the system.

The API may further comprise a gateway, which is accessible for a customer of the service run on the information handling system.

This allows the customer to directly access the API with additional tools. For example, the customer may access the API with individual management tools. An advantage thereof is the flexibility of the management system provided for the customer while he can rely on well-defined tasks offered by the API and provided by the apparatus. This way, the apparatus for managing a service on an information handling system may be incorporated directly via the API gateway, into an existing management system of the customer.

We further provide a computer program comprising instructions which, when the program is executed by a computer, cause the computer to carry out the steps of our methods.

We yet further provide a non-volatile storage medium comprising the computer program.

Advantages and examples disclosed regarding one of the above-mentioned configurations can equally apply to any of the other above-mentioned configurations. Moreover, features disclosed regarding one of the above-mentioned configurations can readily be combined with features of the other above-mentioned configurations.

Further advantages are disclosed in the appended claims as well as the following detailed description of examples. The examples are described with respect to the attached figures.

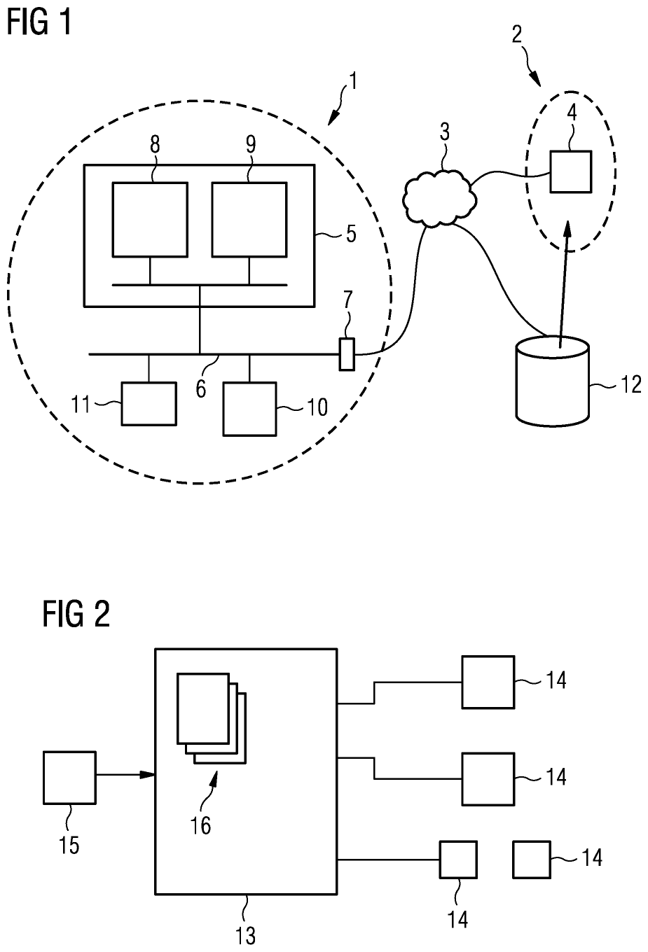

FIG. 1 shows an apparatus 1 for configuring and managing a service on an information handling system 2 according to an example. FIG. 1 further shows the information handling system 2. Apparatus 1 and information handling system 2 are arranged to communicate via a network 3, in this example the Internet. Both, the apparatus 1 and the information handling system 2, comprise multiple entities and features which are described in detail in the following description of FIG. 1. The wording “apparatus” and “information handling system” are to be understood such that those entities can at least partly be implemented as hardware and/or software entities or as a mix of both. Moreover, the information handling system 2 and the apparatus 1 may be each arranged as discrete or distributed systems.

The information handling system 2 comprises an input device 4. The input device 4 is, for example, a computer system such as a desktop computer, a laptop, a workstation or a mobile device such as a tablet or a smartphone. The input device 4 is connected to the network 3 and arranged to receive an input from a customer and to send an input signal via the network 3 to the apparatus 1. In the example as shown in FIG. 1, the input device 4 is part of the information handling system. Alternatively, in particular when the apparatus 1 is used to initially configure the information handling system 2, the input device 4 can also be an external computer system or may even be a computer system comprised in the apparatus 1.

Via the input device 4, a customer, who wants to set up or manage the information handling system 2, is able to input information regarding a service he wishes to acquire. For the customer to input the information regarding the service, a service supplier, who runs the apparatus 1, in this example is able to offer certain services which he is able to provide for the customer. From those offered services, the customer is able to select one or more and input his selection to the input device 4. The offered services may, for example, be offered by the supplier via a web service tool or portal or via an application programming interface, API, to which the input device 4 may be connected.

Possible services in this example, which may be offered to the customer and from which the customer may select one or more, comprise, for example, at least one of the following services: provisioning and orchestrating the information handling system 2, managing the information handling system 2, provisioning, orchestrating and/or managing an SAP system, provisioning, orchestrating and/or managing workplace services, for example, remote workplace solutions, provisioning, orchestrating and/or managing storage services, provisioning, orchestrating and/or managing cloud- and hybrid-IT systems, providing application management services, provisioning, orchestrating and/or managing database services, provisioning, orchestrating and/or managing Azure SQL database instances and many more. A service in this context may also only relate to a part of one of the above.

The information regarding the selected service that the customer inputs via the input device 4, in this example, comprises information specifying which service the customer selects. Moreover, the information regarding the selected service may comprise customer key parameters, CKPs such as parameters regarding an information of the customer, i.e., CKPs specifying who the service selects. For example, those CKPs may comprise a customer ID, information regarding services that this customer already receives, information regarding the information handling system 2 of the customer such as IP addresses, available resources, specification of those resources and many more.

Furthermore, the CKPs may comprise information regarding an extent or size of the service, which is required by the customer. For example, the CKPs may comprise an indication that a service is needed for a certain amount of users and/or the selected service is requested with a storage space of a certain size. Moreover, the CKPs may also comprise an absolute or a maximum prize, which the customer is willing to pay for the selected service. Other CKPs might relate to an indication that the service or parts thereof (e.g., those related to the handling of personal or other critical data) have to be run on an information handling system in a certain territory, an indication that the service or parts thereof have to be run on an information handling system located on-premise with the customer or a provider of the service, in the data center of the service provider, or in the cloud, or an indication whether the service should be run on an information handling system located in one location or multiple locations. In this example, necessary information concerning the CKPs may be prompted from the customer via the input device 4.

The information comprising the specification of the selected service and the CKPs is sent as an input signal via the network 3 to the apparatus 1.

The apparatus 1 comprises a management device 5, which is arranged to receive the input signal from the input device 4. The management device 5 is connected to a communication network 6 of the apparatus 1. The communication network 6 comprises, in this example, an API and a service bus. The API and the service bus are, in this example, independent communication medium. Each entity in the apparatus 1 may be connected either to the API or to the service bus or to both. The apparatus 1 further comprises an API gateway 7, which is connected to the API, and provides a gateway to the network 3.

In the example according to FIG. 1, the management device 5 has a management platform 8 and an execution tool 9. Both, the management platform 8 and the execution tool 9 are connected to the communication network 6. The management platform 8 may, for example, use a management tool such as “Morpheus” from “MorpheusData, LLC.” The management device 5 may rely on one or more execution tools 9 such as, for example, provisioning, configuration management, and application-deployment tools for hardware and/or software. As an example, the execution tool 9 may be the tool “Ansible,” developed by AnsibleWorks, Inc.

The apparatus 1 further has a software repository 10. The software repository is also connected to the communication network 6 and is arranged to communicate with the management device 5 via the communication network 6. In the repository 10, a plurality of blueprints regarding offered services are stored. These blueprints may also be referred to as provisioning pattern. According to this example, each stored blueprint relates to a specific service that is offered by the service supplier. With other words, for each service that is offered by the service supplier, a blueprint is stored in the repository 10.

The blueprints each provide a mapping between one offered service and one or more runbooks. For example, in the blueprint maps multiple runbooks to one service, the runbooks mapped by one blueprint may be a sequence of runbooks. The runbooks, which may also be referred to as execution patterns, comprise instructions for configuring or managing a service of the information handling system 2. With other words, in every blueprint, which relates to a specific service, runbooks are specified, which reflect a sequence of tasks that need to be performed to run the blueprint's service on the information handling system 2.

The blueprints are a combination of library and integration elements, which defines how the information handling system 2 should be set up and/or managed. The blueprints have scripts of programming code, executable by the management platform 8. The management platform 8 can access the blueprints via the communication network 6.

The management platform 8 is arranged to execute a blueprint that has been determined based on the information regarding the selected service. Then, the management platform 8 is arranged to trigger the execution tool 9 to execute the runbooks which are mapped in the blueprint.

The management platform 8 is further arranged to analyze the input signal comprising the information regarding the selected service, i.e., the information regarding which service is selected and the CKPs. The information regarding which service is selected is used by the management platform 8 to select the proper blueprint for the selected service. The CKPs are further analyzed to customize the service for the customer. Since the blueprints are independent from individual features of the customer and the customer's information handling system 2, the customization of the service selected by the customer regarding the customer's specifics is done by executing the runbooks based on customer specific parameters, also referred to as execution parameters.

The CKPs either directly comprise execution parameters, according to which the runbooks are customized for execution, or the CKPs comprise information, which needs to be evaluated to determine the execution parameters. The latter is, for example, when a CKP specifies a maximum prize which the customer is willing to pay to receive a selected service. For example, when the customer requests a service of managed storage and specified a maximum of 1000 € he is willing to pay per month in the CKPs, the management platform 8 is arranged to determine that a maximum of 50 terabytes of managed storage may be provided regarding the received CKP. In that example, the size “50 terabytes” is the execution parameter. In another example, a customer may specify multiple CKPs such as the minimum number of users, the minimum level of reliability (e.g., availability of the service), and/or minimum level of performance (e.g., number of requests a web server can handle per second or number of queries a data base server can handle per second), and the management platform is arranged to determine the number and type of information handling systems (e.g., servers, network devices, storage and the like), which are necessary to run the service meeting all CKPs specified by the customer. In this example, the number and type of the required information handling systems are execution parameters

Depending on the selected blueprint and accordingly the respective runbooks, specific execution parameters need to be determined for the runbooks. Some runbooks may at least partly share the same execution parameters, others may require different execution parameters. The type of execution parameters depends on the runbooks and, accordingly, ultimately depends on the selected service. The herein described determination of execution parameters may alternatively also be performed by any other entity of the apparatus 1 or by an external device.

The management platform 8 is further arranged to determine a provisioning standard for the selected service based on the input signal regarding the selected service. In particular, a type of standard may be selected based on which service and, accordingly, based on which blueprint has been selected. Standardized execution parameters may then be determined, based on the determined standard type and based on the CKP.

The provisioning standards may, for example, be defined regarding an extent or size of the selected service or the information handling system, which is to be configured and/or managed. Different types of provisioning standards may be labeled, for example, as size S, size M, size L and size XL. For example, regarding a provisioning and managing of storage space, size S relates to a storage space of less than 100 gigabytes, size M relates to a storage space between 101 gigabytes and 500 gigabytes, size L relates to a storage space between 501 gigabytes and 1 terabyte and size XL relates to a storage space of more than 1 terabyte. Similar standards may also be defined regarding other subjects, for example, regarding a number of users, for which a service is provided, regarding a number of servers provided, regarding a number of network switches and the like. According to one example, a customer may specify multiple CKPs such as the minimum number of users, the minimum level of reliability (e.g., availability of the service), and/or minimum level of performance (e.g., number of requests a web server can handle per second or number of queries a data base server can handle per second), and the management platform is arranged to determine a provisioning standard, which meets all CKPs specified by the customer. For example, according to the above-mentioned S, M, L, and XL standard sizes, the management platform is arranged to choose the minimum size which meets all CKPs specified by the customer.

For example, according to the above-mentioned S, M, L, and XL standard sizes, a number of network switches and/or servers is standardized. In particular, irrespective of whether the customer selects the service “provisioning and managing of storage space” with a CKPs of 600 gigabyte or 800 gigabyte of storage, both CKPs fall within the standardized “size L,” which is able to support a storage size up to 1000 gigabyte while “size M” would only support 500 gigabyte. Accordingly, in both configurations, irrespective of whether 600 or 800 gigabyte are specified in the CKP, the same amount of servers and network switches is provided, irrespective of the exact amount of requested storage space.

According to the example as shown in FIG. 1, for each offered service, i.e., for each blueprint, at least one standard is defined. In particular, for each execution parameter that needs to be specified for executing the runbook, a standard is defined. Alternatively, standards may be defined only for those execution parameters, which cause a significant complexity to the configuration and/or managing of the information handling system 2, when individual values are used.

Also regarding the same subject, for example, the subject “storage space,” different standards may be defined for different services. For example, while a storage space standard in a “managed storage space” service may define size S as less than 100 gigabytes, a storage space standard in a “managed operating system” service may define size S as less than 500 gigabytes. The standards may be defined according to preferences of a supplier and/or according to needs of customers.

The execution tool 9 is arranged to execute the runbooks according to the standardized execution parameters and/or according to individual execution parameters. In particular, when the respective blueprint signals a sequence of runbooks, the respective runbooks are sequentially executed.

In the example according to FIG. 1, for example, the customer selected a service of “provisioning and managing a workplace environment.” Accordingly, the following runbooks are some of the sequence of runbooks that is indicated by a respective blueprint for the service: provisioning storage space, installing virtual machines and operating systems, installing applications, orchestrate a service management integration, and perform management such as monitoring services, backup services and the like for the workplace environment. Those runbooks are then executed by the execution tool 9 and the respective tasks are performed.

To install software during provisioning and configuration of the information handling system 2, the management device 5 and/or the information handling system 2 has access to according software repositories to download the required software. To provision a cloud based information handling system 2, the management device 5 has access to such cloud platforms.

For the task of provisioning storage space, the execution tool 9 selects, in the example as shown in FIG. 1, a respective amount of storage from a storage device 12. The storage device 12 is in this example a storage server from which a respective storage space is allocated to the information handling system 2. The storage device 12 is, for example, a storage device that belongs to the supplier of the service. Alternatively, the storage device 12 may be a storage device of an external provider, e.g., cloud storage, or may be a storage device of the customer. This way, a service may be immediately provided when the supplier has enough storage space available.

The apparatus 1 further has a configuration management database, CMDB, 11, which is connected to the communication network 6. The CMDB 11 is a central CMDB that stores all important information regarding customers and information handling systems that are provisioned and managed by the apparatus 1. The CMDB 11 is further arranged to access local data sources of information handling systems to gather information regarding those systems. Based on the CMDB 11, the apparatus is arranged to provide reports regarding the information handling system in real-time. For example, when a new customer is recognized, when first services are provisioned and orchestrated, or when a running service is changed, information regarding all those tasks and others may be stored in the CMDB 11. The information is automatically gathered and stored in the CMDB 11. For example, whenever an information handling system which runs a service is provisioned and configured for the first time or when it is changed, updated or re-configured due to the execution of a blueprint or a runbook, the blueprint and/or the runbook are arranged to update the CMDB accordingly so that the CMDB always provides valid data on the information handling system.

FIG. 2 shows a structural diagram of a blueprint 13 and multiple runbooks 14 according to an example. The blueprint 13 and runbooks 14 shown in FIG. 2 may be used, for example, as the blueprint and runbooks of the apparatus 1 of FIG. 1.

FIG. 2 shows the blueprint 13 for a service of provisioning and managing storage. The structural diagram of FIG. 2 shows the blueprint 13 and runbooks 14 in a highly simplified manner. In other examples, blueprints 13 and runbooks 14 may have a higher level of complexity.

The blueprint 13 maps the selected service of providing and managing storage to the respective runbooks 14, which need to be executed to provision and configure the information handling system which runs the service. Other runbooks 14 may exist, which are not mapped by the blueprint 13 shown in FIG. 2.

An input to the blueprint 13 are CKPs 15. Those CKPs 15 comprise in this example the information that the customer selected an L-sized managed storage.

The blueprint 13 comprises provisioning standards 16, which identify that for an L-sized managed storage, 1 terabyte of storage space needs to be allocated. In other examples or for other selected services, the CKPs do not comprise information on a selected provisioning standard but the determined blueprint determines a provisioning standard based on the CKPs. The provisioning standards are discussed in further detail with respect to FIG. 1, which is not repeated herein.

The blueprint 13 maps a sequence of runbooks 14 to the service of the blueprint 13. Those runbooks 14 are customized according to the CKPs, i.e., the standardized execution parameter, which is derived from the CKPs 15. One of the runbooks 14 that is mapped to the blueprint 13 is a runbook 14 for “allocating an amount of X gigabyte of a storage device.” In the step of customizing the runbooks 14, this runbook 14 would be customized in the example described herein to “allocating an amount of 1000 gigabytes of a storage device.”

The customized runbooks 14 are then executed. Accordingly, initially a first one of the runbooks 14 is executed, to allocate an amount of 1000 gigabytes of storage. Subsequently, further runbooks 14 that are mapped by the blueprint 13 are executed to provide the service. Those further runbooks 14 may comprise, for example, tasks for performing a backup of the storage and the like.

Moreover, the runbooks 14 that are mapped by the blueprint 13 may have dependencies on the provisioning standard or on each other. For example, when a standard size of L or XL is selected, storage space from different storage devices is allocated to provide additional reliability. When a standard size of S or M is selected, however, only storage space on one storage device is allocated. Accordingly, when a certain standard is selected in the blueprint 13, certain runbooks 14 may be executed or not, depending on the respective dependencies.

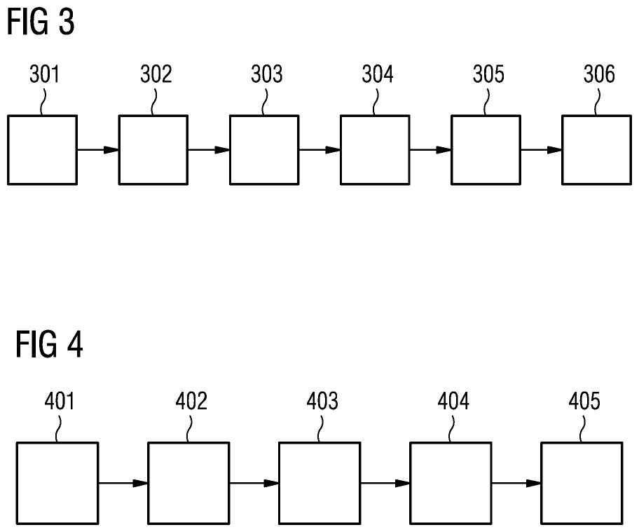

FIG. 3 shows a flowchart of a method 300 for configuring an information handling system according to an example. The method of FIG. 3 may be performed by the apparatus disclosed with regard to FIG. 1.

In a first step 301, an input signal is detected regarding a service. The service is a service selected by a customer, wherein the input signal comprises information regarding the selected service. The input signal comprises in particular information regarding which service is selected and regarding CKPs, a detailed description of which is not repeated herein.

In a second step 302 at least one blueprint from a plurality of stored blueprints is determined based on the information regarding the selected service, wherein each blueprint of the plurality of blueprints provides a mapping between a service and at least one runbook. Each runbook comprises instructions for configuring an information handling system. The runbook and blueprint in this example may correspond to the runbooks and blueprints discussed in detail with regard to FIGS. 1 and 2.

In a third step 303, the information regarding the selected service, including, for example, the CKPs, is analyzed based on the determined at least one blueprint. Depending on the selected service, i.e., the determined at least one blueprint, the analysis might be very simple or quite complex (involving multiple automated decisions based on the information regarding the selected service including, for example, the CKPs) to provide the necessary input for the next steps.

In a fourth step 304, at least one runbook from a plurality of runbooks is determined and at least one execution parameter is determined, both based on the determined at least one blueprint and the information regarding the selected service including, for example, the CKPs, according to step 303.

In a fifth step 305, the at least one determined runbook is executed based on the determined at least one execution parameter.

In a sixth step 306, a result of the configuration of the information handling system is fed back to a configuration management database, CMDB. This may, for example, comprise information regarding the customer and/or regarding the configured information handling system.

FIG. 4 shows a flowchart of a method 400 for managing a service on an information handling system according to an example. The method of FIG. 4 may be performed by the apparatus described with regard to FIG. 1.

In a first step 401, a task of a service running on an information handling system, which task is to be executed, is determined. The task of the service may be triggered by a customer requesting, for example, a change of a service provided to him, or may be a reoccurring task or independently triggered task. A reoccurring or independently triggered task may be triggered, for example, by a service platform. The service platform may be based, for example, on an IT service platform such as the cloud platform “ServiceNow.” The reoccurring or independently triggered task may be triggered, for example, based on information that is stored in the CMDB. A reoccurring task may be, for example, an updating of a service or of an information handling system provided for the customer or performing a scheduled backup. Furthermore it may be possible that the task is triggered, for example, by an executed execution pattern.

In a second step 402, information regarding the service running on the information handling system is requested from a configuration management database, CMDB. The information regarding the service comprises information regarding at least one blueprint, based on which the information handling system is configured and about the actual configuration of the information handling system which resulted from the configuration based on the at least one blueprint and subsequent configuration changes applied to the information handling system, e.g., according to the method described in FIG. 4.

In a third step 403, at least one runbook from a plurality of runbooks according to the information regarding the service and regarding the task which is to be executed is determined.

In a fourth step 404, the at least one determined runbook is executed. The runbook and blueprint in this example may correspond to the runbooks and blueprints discussed in detail with regard to FIGS. 1 and 2.

In a fifth step 405, the configuration management database, CMDB, is updated according to the execution of the at least one determined runbook and its result.

The method described regarding FIGS. 3 and 4 are computer-implemented methods.

1-18. (canceled)

19. A method of configuring an information handling system, the method comprising:
detecting, by a management device, an input signal regarding a service, which service is selected by a customer, wherein the input signal comprises information regarding the selected service and wherein the information handling system is to be configured for the selected service;
determining, by the management device, at least one provisioning pattern from a plurality of stored provisioning patterns based on the information regarding the selected service, wherein each provisioning pattern of the plurality of provisioning patterns provides a mapping between a service and at least one execution pattern;
determining, by the management device, at least one execution pattern from a plurality of execution patterns based on the determined at least one provisioning pattern, wherein each execution pattern comprises computer readable instructions for configuring an information handling system;
determining, by the management device, at least one execution parameter based on the determined at least one provisioning pattern; and
executing, by the management device, the at least one determined execution pattern based on the determined at least one execution parameter to configure the information handling system for the selected service.

20. The method according to claim 19, wherein before the step of detecting, by a management device, an input signal, the method further comprises:
displaying, by a displaying device, information regarding at least one service for which at least one service pattern is stored, wherein the service selected by the customer comprises at least one of the displayed services.

21. The method according to claim 19, wherein the determining, by the management device, at least one execution pattern from a plurality of execution patterns is further based on the information regarding the selected service.

22. The method according to claim 19, wherein the at least one execution pattern comprises at least one executable script comprising the instructions for configuring the information handling system.

23. The method according to claim 19, wherein at least one execution pattern is mapped by at least two different provisioning patterns to at least two different services.

24. The method according to claim 19, wherein the step of determining, by the management device, at least one execution parameter comprises:
analyzing the information regarding the selected service of the input signal;
determining at least one provisioning standard for the selected service based on the analyzed information regarding the selected service; and
determining the at least one execution parameter based on the determined at least one provisioning standard.

25. The method according to claim 24, wherein the determining, by the management device, at least one execution pattern from a plurality of execution patterns is further based on the at least one determined provisioning standard.

26. An apparatus for configuring an information handling system and/or managing a service on an information handling system, the apparatus comprising a management device, wherein, to configure the information handling system, the management device is configured to:
detect an input signal regarding a service, which service is selected by a customer, wherein the input signal comprises information regarding the selected service and wherein the information handling system is to be configured for the selected service;
determine at least one provisioning pattern from a plurality of stored provisioning patterns based on the information regarding the selected service, wherein each provisioning pattern of the plurality of provisioning patterns provides a mapping between a service and at least one execution pattern, and wherein each execution pattern comprises computer readable instructions for configuring an information handling system;
determine at least one execution pattern from a plurality of execution patterns based on the determined at least one provisioning pattern;
determine at least one execution parameter based on the determined at least one provisioning pattern and the information regarding the selected service; and
execute the at least one determined execution pattern based on the determined at least one execution parameter to configure the information handling system for the selected service;
and/or wherein for managing the service on the information handling system, the management device is configured to:
determine a task of a service running on an information handling system, which task is to be executed;
request, from a configuration management database, CMDB, information regarding the service running on the information handling system, wherein the information regarding the service comprises information regarding at least one provisioning pattern, based on which the information handling system is configured;
determine at least one execution pattern from a plurality of execution patterns according to the information regarding the service and regarding the task which is to be executed; and
execute the at least one determined execution pattern to manage the service on the information handling system.

27. The apparatus according to claim 26, further comprising at least one storage device, wherein the plurality of provisioning patterns and/or the plurality of execution patterns are executable scripts, stored on the at least one storage device.

28. A method for managing a service on an information handling system, the method comprising:
determining, by a management device, a task of a service running on an information handling system, which task is to be executed;
requesting, by the management device, from a configuration management database, CMDB, information regarding the information handling system that is running the service, wherein the information regarding the information handling system comprises information regarding at least one provisioning pattern, based on which the information handling system is configured;
determining, by the management device, at least one execution pattern from a plurality of execution patterns according to the information regarding the information handling system that is running the service and regarding the task which is to be executed; and
executing, by the management device, the at least one determined execution pattern to manage the service on the information handling system.

29. The method according to claim 28, further comprising:
detecting, by the management device, an input signal regarding a task of a service running on an information handling system, which task is to be executed, wherein the input signal comprises information regarding the task, wherein determining, by a management device, a task of a service running on an information handling system, which task is to be executed is based on the detected input signal.

30. The method according to claim 28, wherein the execution pattern comprises:
instructions for managing the selected service on the configured information handling system, and/or
instructions for changing a configuration of the information handling system.

31. The apparatus according to claim 27, wherein the management device, the storage device and the CMDB are connected via a communication network and/or a service bus and/or an application programming interface, API.

32. The apparatus according to claim 31, wherein the API comprises a gateway, which is accessible for a customer of the service run on the information handling system.
